(19) United States
(12) Patent Application Publication
(10) Pub. No.: US 2026/0248677 A1
(43) Pub. Date: Aug. 27, 2026

(54) APPARATUS FOR WALKING AND REHABILITATION SAFETY

(71) Applicant: Thomas James Rowan, Cincinnati, OH (US)

(72) Inventors: Thomas James Rowan, Cincinnati, OH (US); Joshua Lee Fuller, Cincinnati, OH (US)

(21) Appl. No.: 19/451,717

(22) Filed: Jan. 16, 2026

Related U.S. Application Data
(63) Continuation of application No. PCT/US24/38579, filed on Jul. 18, 2024.
(60) Provisional application No. 63/628,409, filed on Jul. 18, 2023.

(51) Int. Cl. A61H 3/00; A61H 3/04

(52) U.S. Cl. CPC A61H 3/008; A61H 3/04; A61H 2003/007; A61H 2201/0192; A61H 2203/0406

(57) ABSTRACT

This invention is directed to an apparatus to assist a user in the act of walking and specifically is directed to ensuring user comfort and safety in the act of walking or in other ambulation of the body.

### PRIORITY CLAIM

This application is a continuation of Intl. App. No. PCT/US24/38579, filed on Jul. 18, 2024. Intl. App. No. PCT/US24/38579 claims the benefit of U.S. Provisional Application Ser. No. 63/628,409, filed on July 18,2023. The previous applications are incorporated herein by reference in their entireties.

### TECHNICAL FIELD

This invention is directed to an apparatus to assist a user in the act of walking and specifically is directed to ensuring user comfort and safety in the act of walking or in other ambulation of the body.

### BACKGROUND OF THE INVENTION

For a number of reasons, a person may require assistance in the act of walking or other ambulation, such as because of age or rehabilitation. To that end, a number of walking aids and assistance structures have been utilized. However, the issue of falling during such activities still has remained a concern. Various available devices are large and cumbersome. Furthermore, they do not fit a user sufficiently or are difficult to manipulate or use. Still further, they do not provide sufficient support from a fall as often users will walk behind such a device and can fall with the device. Many that have wheels for rolling the device also provide a hazard as a slip or stumble motion tends to push such a device forward wherein it will easily roll out from under the user. An additional drawback is that many such walking aids are directed either to walking assistance or rehabilitation, but not both.

Therefore, there is still a need in the industry for improvement in an apparatus that may be used to provide safe walking and a safe and comfortable rehabilitation environment for those rehabilitating from an injury or surgery that need assistance in their ambulation.

The above and other objects and advantages in accordance with the principles of the present invention shall be made apparent from the accompanying drawings and the description thereof.

### SUMMARY OF THE INVENTION

An apparatus for walking safety includes a frame with four vertical members defining corners of the frame and a front, a rear and opposing sides. Each of the vertical members is adjustable in length to adjust a height of the frame. At least one side beam is coupled with vertical members on opposing sides of the frame. At least one front horizontal member is coupled between vertical members on the front of the frame. The front horizontal member adjustable in length for adjusting the width of the frame. Horizontal support members are coupled with vertical members on opposing sides of the frame and the horizontal support members are coupled proximate to top ends of respective vertical members. An arm structure is coupled to the frame on either side of the frame. A harness is coupled to the frame for supporting a user of the apparatus.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention. Similar reference numerals are used to indicate similar features throughout the various figures of the drawings.

FIG. 1 is a front perspective view of an embodiment of an apparatus in accordance with of the invention.

FIG. 2 is a front view of the embodiment of the apparatus of the invention as shown in FIG. 1.

FIG. 3 is a rear view of the embodiment of the apparatus of the invention as shown in FIG. 1.

FIG. 4 is a right side view of the embodiment of the apparatus of the invention as shown in FIG. 1.

FIG. 5 is a left side view of the embodiment of the apparatus of the invention as shown in FIG. 1.

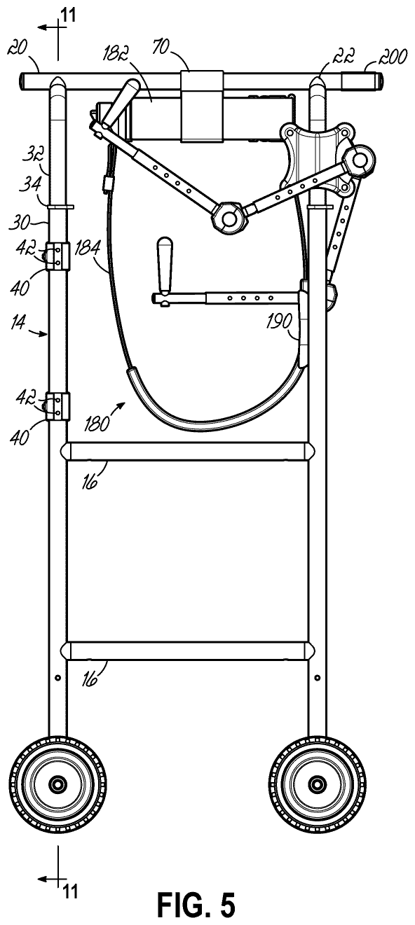

FIG. 6 is a top view of the embodiment of the apparatus of the invention as shown in FIG. 1.

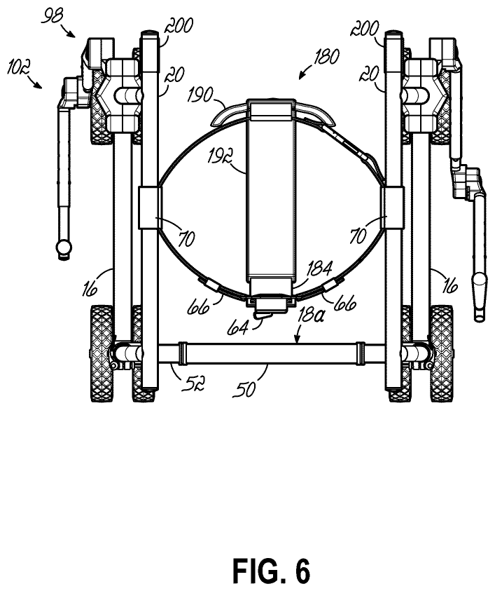

FIGS. 7 and 8 are exploded views of an arm structure of the embodiment of the apparatus of the invention as shown in FIG. 1.

FIGS. 9 and 10 are perspective views of wheels used on the frame of the embodiment of the apparatus of the invention as shown in FIG. 1.

FIG. 11 is front cross-sectional views of wheels used on the frame of the embodiment of the apparatus of the invention as shown in FIG. 1.

### DETAILED DESCRIPTION OF EMBODIMENTS OF THE INVENTION

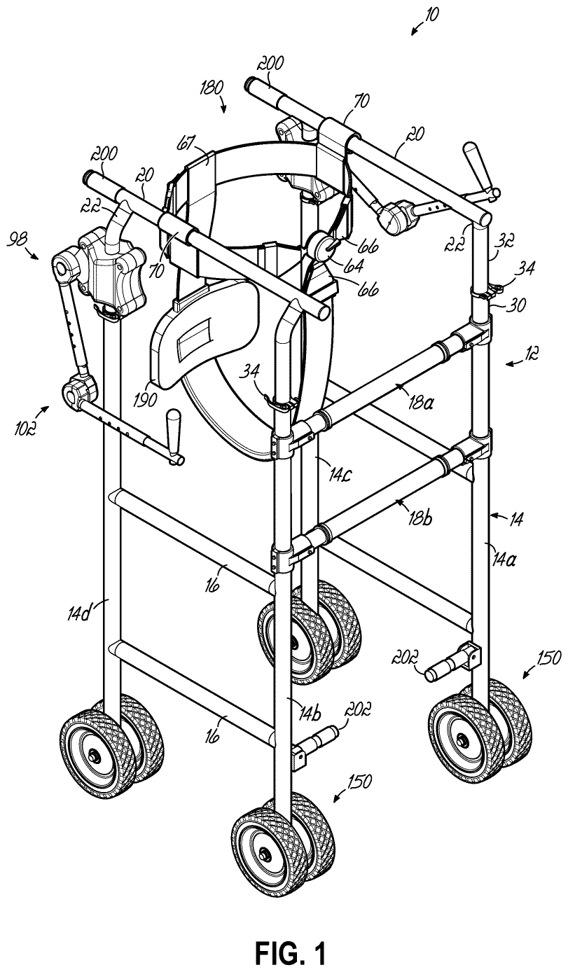

FIG. 1 is a perspective view of an apparatus for walking, exercising and rehabilitation safety in accordance with the invention. The apparatus 10 provides a unique apparatus for engagement by a user or patient to assist in the activity of walking, whether for rehabilitation and recovery, or for the simple act of ambulation, such as for exercise. It captures and secures a user to allow safe walking, and also provides resting or sitting features, as desired by a user in their rehabilitation or other user of the apparatus. Elements of the apparatus 10 support a user under their armpits to provide a crutch-based ambulation and movement that is familiar to many users for comfort and ease of use. To that end, the apparatus provides grips that are uniquely adjustable is several axes for the ease and comfort of the user. The apparatus 10 rolls on a plurality of wheels for smooth ambulation and further incorporates a weight-activated braking system. Should a user stumble as a prelude to a fall, such as if a user were to become dizzy or even pass out, the system brakes the further rolling or movement of the apparatus, while the harness prevents a fall and provides support through the apparatus 10.

Turning to FIG. 1, the apparatus 10 has a frame 12 that is adjustable in height and width for various users. The frame 12 includes a plurality of elongated vertical members 14 that are arranged at 4 corners to form a box structure that a user may enter to use the apparatus 10. Two forward vertical members 14a, 14b define a front of the frame and two rear members 14c, 14d define a rear of the frame 12 so that the vertical members define corners of the frame. The frame 12 is generally boxlike with a front, a rear, and two opposing sides. A series of generally horizontal cross beams connect the vertical members 14 to form the frame 12. Specifically, one or more side beams 16 are used to connect or couple the vertical members 14a, 14c to form one side of frame 12 and one or more side beams 16 are used to connect or couple the vertical members 14b, 14d to form the other or opposing side of the frame. The side beams 16 are appropriately coupled with the respective vertical members 14, such as by bolts, screws or other fasteners. Alternatively, they might be welded to the vertical members. In one embodiment, as illustrated herein, the side beams have a fixed length. Alternatively, they might be adjustable.

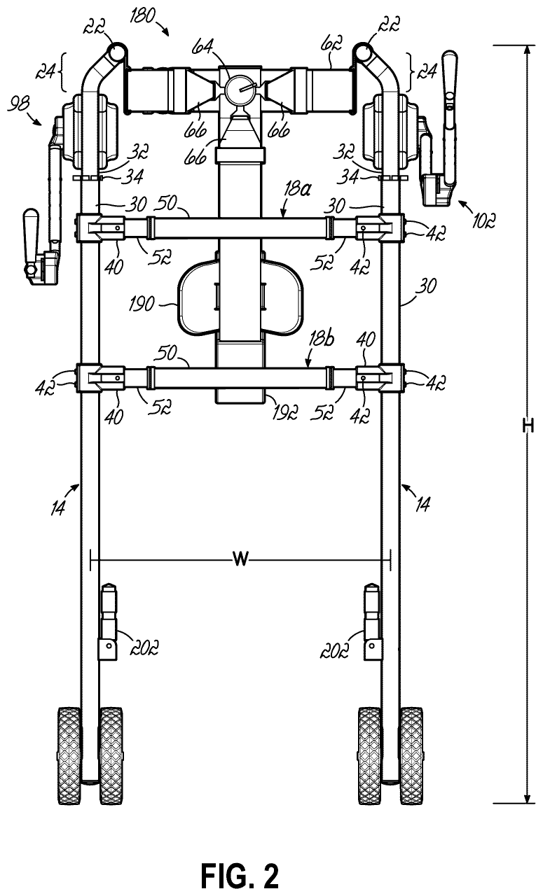

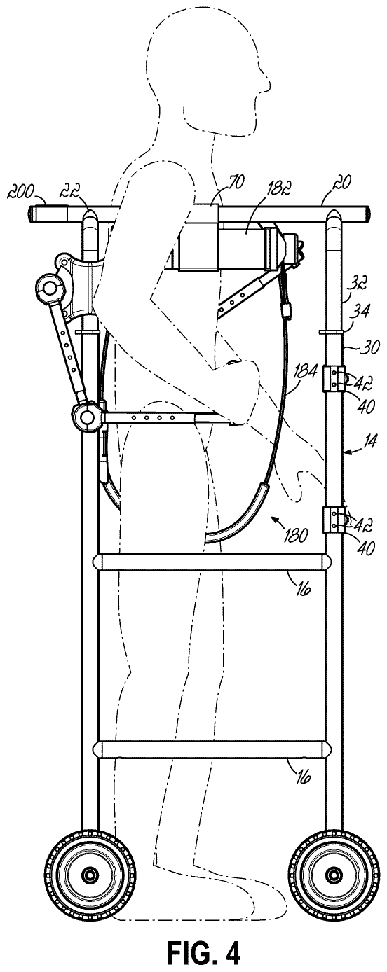

One or more front horizontal members, 18a, 18b are also coupled or connected to each of the forward vertical members 14a, 14b to generally form a box-like frame 12. The rear of the frame is left open for entry of a user, as discussed herein. For supporting the body and arms of a user who is walking or moving in the apparatus 10 (see FIG. 4), the frame also includes generally horizontal support members 20 that extend front to back on the frame 12 similar to side beams 16. The support members 20 are appropriately coupled proximate to or at the top ends 22 of respective vertical members 14 on opposing sides of the frame, such as by bolts, screws or other fasteners. The support members 20 are received under the arms of a user when the user is in the frame. Alternatively, they might be welded to the vertical members. For better positioning of the support members 20 under the arms of a user, but to ensure a width inside the frame for suitable leg movement and walking, the top ends 22 of the vertical members might include angled sections 24 as illustrated in FIG. 2. As shown in FIG. 1, the rearward ends of the horizontal support members 20 might be grasped and manipulated, such as by a caregiver or medical professional, to push or otherwise manipulate the apparatus to assist a user. For example, the ends might be grasped similar to a wheelchair to assist until a user was comfortable using the apparatus on their own. To that end, grip handles 200 might be implemented at the rearward ends of the horizontal support members 20 to assist in gripping and handling the apparatus.

In accordance with features of the invention, the height H as well as the width W of the frame is adjustable or controllable. In the illustrated embodiment, each vertical member 14 may be adjusted in length to adjust the height of the frame 12. For providing adjustment, each vertical member 14 includes an outer section or tube 30 that receives a smaller inner section or tube 32 that may telescope inside the outer tube 30. Referring to FIG. 2, the inner tube 32 of each respective vertical member 14 includes the top end 22 coupled with the support members 20 and angled sections 24. The inner tube slides or telescopes vertically in outer tube 30 to raise the height of the support members 20 and thus raise the height of the frame. In one embodiment, the inner tube and outer tube are configured to provide a height adjustment of approximately 12 or so inches, although a greater or lesser amount of adjustment may be used. More specifically, the frame 12 may range in height from 5 feet, 5 inches to 6 fee, 4 inches. As will be appreciated, other suitable ranges might be achievable with the telescoping inner tubes 32 and outer tubes 30. For example, a children's model and a smaller model for aging adults (petite), that would be adjustable for a range of 4 feet, 10 inches to 5 feet, 6 inches may be used. An apparatus for children could be a overall sized in width and depth and height for a child, whereas a smaller adult one would just have the ability to adjust to a shorter height but keep the same size of the adult frame 12. As appreciated, for even orientation, each of the four vertical members 14 could be adjusted to the same height, although that is no required.

To secure the desired height H of the frame 12, mechanisms 34 may be used as shown in FIGS. 2 and 4, for example. In one embodiment of the invention, mechanisms 34 in the form of cammed tube locks may be used. Cam mechanisms 34 squeeze or clamp the outer tube 30 around the inner tube 32 to lock or fix the length of the vertical member and tubes and secure the telescoping height of the vertical members 14. For example, cam mechanisms from GINEYEA of Shenzhen China may be utilized for quick release adjustments. Alternatively, another clamping mechanism, such as a clamp tightened with a set screw might be implemented for clamping the outer tube 30 with the inner tube. Still other mechanisms, such as a spring loaded ball or bearing in one tube engaging with spaced apertures in another tube might be implemented as discussed herein with other elements of apparatus 10.

The front horizontal members, 18a, 18b control or adjust the width W of the embodiment illustrated since the back of the frame remains open for a user to step into the frame. The front horizontal members, 18a, 18b are adjustable in length and are secured at their end with the vertical members 14a, 14b appropriate T-clamps 40 that are positioned on the vertical members at the desired height and then secured with fasteners, such as set screws 42. The ends of the front horizontal members, 18a, 18b are then coupled with the T-clamps 40 and secured with fasteners, such as set screws 42. To provide a width adjustment, the front horizontal members, 18a, 18b telescope for moving the vertical elements 14 further apart or closer together. To that end, in the illustrated embodiment, the telescoping pieces are threaded so that by rotation of one of the pieces, the other piece moves away thus lengthening the overall horizontal member. For example, referring to FIG. 2, each horizontal member, 18a, 18b incorporates a larger dimensioned section 50 that receives one or more smaller dimensioned sections 52 so that the sections 52 telescope in the section 50 to vary the length of the horizontal member and the width of the frame. In the illustrated embodiment, the horizontal member is tubular and includes a larger diameter section 50 that receives one or more smaller diameter sections 52 so that the sections 52 telescope in the section 50. By rotation of one of the sections, such as section 50, the other section(s) 52 telescope outwardly or inwardly.

In one embodiment, the sections 50, 52 have appropriate threads and reverse threads (not shown) on the ends that allow them to threadedly engage. The sections rotate relative to each other and expand or shorten in length based on the relative rotation with respect to each other. In the illustrated embodiment, a center section 50 engages with another section 52 at each end. Rotation of the center section 50 allows the end section to extend outward or retract inward with respect to the center section 50 thus changing the length of the front horizontal members, 18a, 18b. Alternatively, the sections 50, 52 of the front horizontal members, 18a, 18b might incorporate a friction lock to set the length of the telescoping sections 50, 52. Alternatively, another clamping mechanism, such as a cam mechanism as described herein, a clamp tightened with a set screw, or a spring loaded ball in one tube engaging with spaced apertures in another tube might be implemented as discussed herein with other elements of apparatus 10 in order to fix the length of the front horizontal members, 18a, 18b. In that way, the width W of the frame 12 might be adjusted. In accordance with one feature, the various sections 50, 52 are marked appropriately with length markings to ensure that each front horizontal members, 18a, 18b has the same length.

For ease of usage and comfortable operation by a user, the apparatus 10 includes arm structures or arms 90 with a grip handle 104. The arms 90 are on either side of the frame and allow a user to steer, push, guide and/or lift the frame 12. Each arm 90 includes a plurality of elbow structures 98,102 that allow for a wide range of positioning of the grip handle 104. The elbows define are sections 96 and 100 of the arm 90. Those arm sections 96, 100 may be independently manipulated for desired length of the arm for the user and positioning of the grip handle.

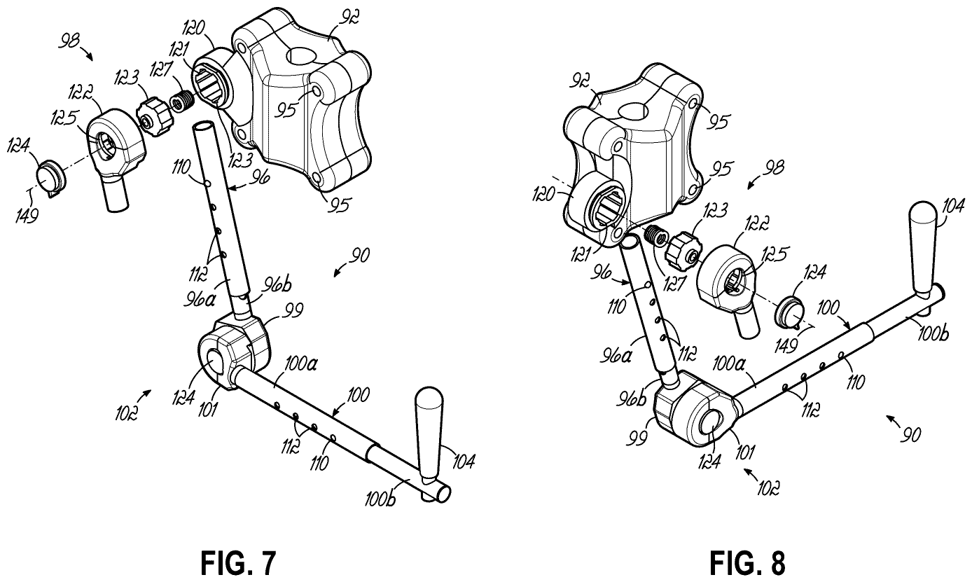

To that end, referring to the FIGS. 7 and 8, an arm 90 is shown. The arm 90 includes a mount 92 that has an appropriate aperture 93 for mounting the arm to vertical members 14c and 14d of the frame 12 as shown in FIGS. 1 and 2, for example. The mount 92 might be two pieces of halves that come around the vertical members and then are held together in place by fasteners (not show) in holes 95 between the halves. The mount 92 of each arm includes portion 120 of elbow structure 98 that interfaces with a companion portion 122 of the elbow structure 98. Portion 122 is configured to rotatably interface with portion 120 and so can rotate on portion 120 of the mount 92 to change the position of the arm 90. The arm 90 elbow structure 102 includes portions 99 and 101 that are similar to the other elbow structure 98 in their operation.

As shown in the exploded view of FIG. 7, the portions 120, 122 of the elbow structure capture a sprocket 123 that includes a plurality of teeth therearound. Each portion 120, 122 of the elbow structure includes a respective cavity 121, 125 that has a shape that is keyed to match the teeth of the sprocket 123. When the elbow structure 98 is assembled, as shown in FIG. 1, the sprocket 123 is captured in the cavities 121, 125 and spans the interface between the portions 120, 122. Therefore, the teeth of the sprocket are received into both keyed cavities and thus prevents one elbow portion 122 from rotating with respect to the other elbow portion 120 on the mount 92. The sprocket seats in the various cavities 121, 125 and is biased by a spring from the cavity 121 of the mount towards the cavity 125 in elbow portion 122. As such, in the rest position, the sprocket 123 and portions 120, 122 are locked together so the orientation of the arm section 96 is locked relative to the mount 92 and frame 12.

To adjust the position of the arm section 96, a push button 124 also seats in the elbow portion 122 adjacent to the sprocket and in line with the spring 127. Pushing the button 124 into the elbow 98 drives the sprocket 123 against the spring and thereby drives the sprocket out of the cavity 125 of the elbow portion 122 and into the cavity 121 of the elbow portion 120. In that way, the elbow portion 122 is no longer engaged with the sprocket and is free to rotate relative to the elbow portion 120 and mount 92 on the frame. The arm section 96 can then be rotated around an axis 150 defined by the elbow portions, the sprocket and the button, while the button is depressed. When the button is released, the spring and spring bias drives the sprocket back into engagement again with the elbow portion 122 in cavity 125. The sprocket is thus again seated between the two elbow portions 120, 122 and the elbow portions are prevented from rotating with respect to each other. The arm section 96 is thus again locked and held in place at the desired position.

The arm section 96 has additional adjustability in positioning provided by a telescoping motion of the arm section. Specifically, the arm section includes two telescoping elements 96a, 96b that fit together and can telescope or slide with respect to each other to provide a length adjustability to the arm section 96. The telescoping elements 96a, 96b implement an indexing system for selecting the desired length of the arm section 96. In the illustrated embodiment, a spring loaded ball or bearing 110 in one element, such as element 96b, engages with spaced apertures 112 in another element, such as element 96a, and arm section 96 may thus be selectively indexed to a desired length by pushing in the bearing 110 and sliding the element 96b until the bearing engages another aperture 112.

In accordance with another feature of the invention, to provide even greater adjustability to the arm 90 and positioning of the grip handle 104, elbow structure 102 is coupled with an end of the arm section 96. Specifically, an elbow structure portion 99 is coupled to the end of arm section element 96b and interfaces with portion 101 of the elbow structure to provide selective rotation and angular orientation of the arm section 100 relative to arm section 96. The elbow structure 102 is configured and operates similar to the elbow structure 98, as described herein, and may be selectively locked and unlocked, via button 124, to be rotated to a desired position and then locked in that position. The portion 101 rotates relative to elbow structure portion 99 and arm section 100 is coupled with elbow structure portion 101. Similar to arm section 96, the arm section 100 includes two telescoping elements 100a, 100b that fit together and can telescope or slide with respect to each other to provide a length adjustability to the arm section 100. The telescoping elements 100a, 100b implement an indexing system for selecting the desired length of the arm section 100. In the illustrated embodiment, a spring loaded ball or bearing 110 in one element, such as element 100b, engages with spaced apertures 112 in another element, such as element 100a, and arm section 100 may thus be selectively indexed to a desired length by pushing in the bearing 110 and sliding the element 100b until the bearing engages another aperture 112. The arms 90 are positioned on each side of frame as shown in the figures for allowing a user to move, manipulate and steer the structure as desired in their ambulation and walking.

Grip handle 104 is fixed to an end of the arm section 100, such as to an end of element 100b. Therefore, through the additional rotation of elbow structure 102 and a length adjustment to arm section 100, the grip handle 104 may further positioned as desired for the user for securing the user with the frame and allowing the user to manipulate the frame. For example, as shown on one side of FIG. 1, the arm may be rotated and lengthened to a lower position, such as a person might use in implementing the frame 12 similar to a pair of crutches in support. Alternatively, the arms might be raised, as shown on the other side of FIG. 1, so that a user might have a better grip or arm position to steer or lift the frame somewhat. In that way, the grip handles may be oriented to be generally vertical or horizontal or could be oriented at any desired angle therebetween for the user's use and comfort. Each user can tailor the arm location and length and grip handle location for comfort and utility in the way the apparatus is used, such as for rehabilitation, walking assist, turning or steering the frame 12, etc.

For movement of the frame 12 in ambulation, the apparatus 10 incorporates at least one wheel at the bottom end of each vertical member 14. In the illustrated embodiment the apparatus 10 incorporates a set of wheels at the bottom end of each vertical member 14. Specifically, referring to FIGS. 1 and 9-11, sets of wheels 150 are positioned at each of the bottom ends of the vertical members 14 so that the frame may roll along a surface. In accordance with one aspect of the invention, the apparatus incorporates and weight-activated breaking feature to ensure the safety and safe support by a user and to prevent a fall or other injury during usage, such as from a user stumbling, passing out or otherwise become incapacitated during use.

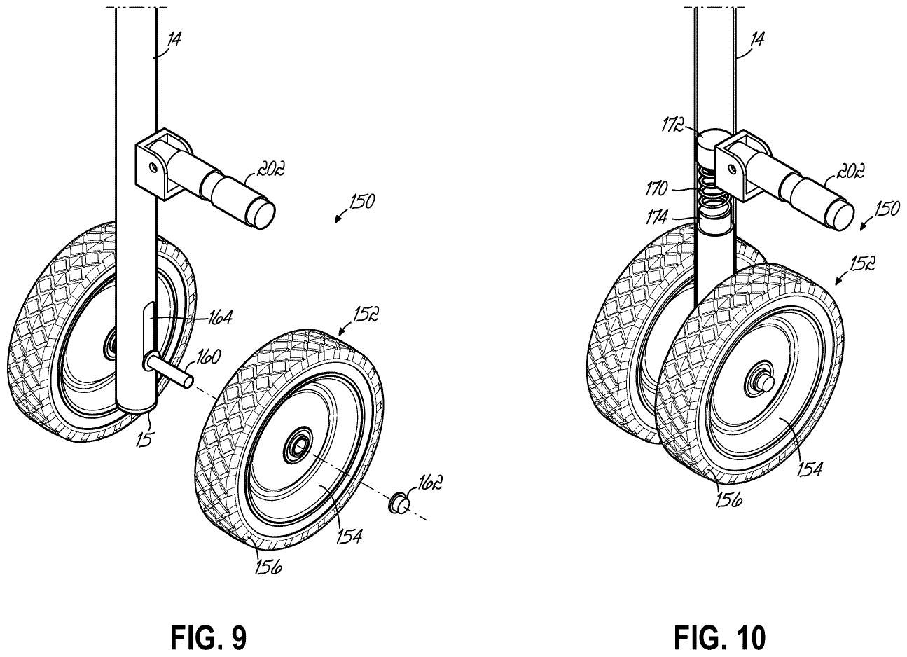

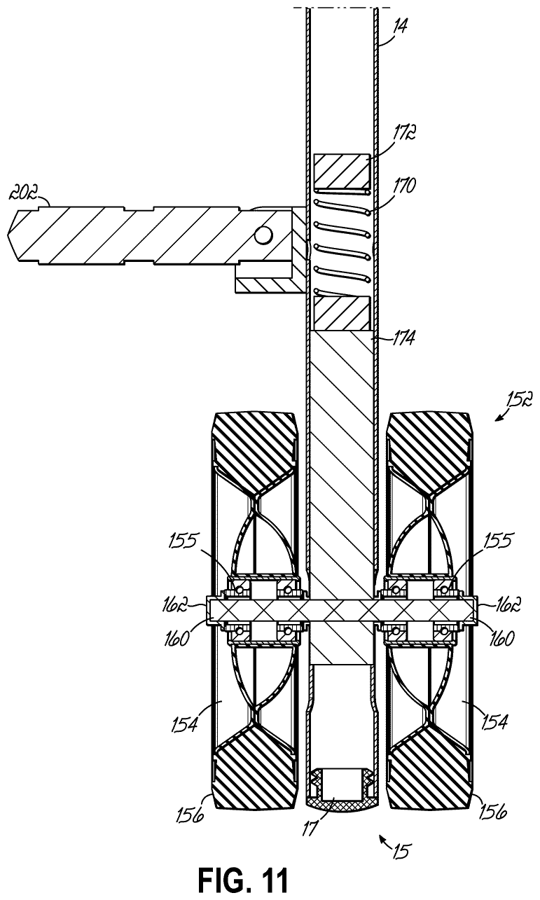

Turning to FIGS. 9-11, a plurality of wheels 152 (in the illustrated embodiment, 2 wheels per set) form each set at the corners of the frame 12 and the bottom of each vertical member 14. The wheels 152 may be an appropriate wheel for floor surfaces and include a rim 154 and tread 156. The wheels 152 are secured to rotate on either end of an axle 160 with end caps 162. The axles pass through bearing elements 155 of the wheels as shown in FIG. 11 for smooth rolling. The axles 160 also pass through appropriate holes or openings 164 formed in the lower ends of the vertical members 14. In accordance with the weight-activated braking feature of the invention, the opening 164 is in the form of an elongated slot that receives the axle 160 as seen in FIG. 9. The axle 160 and wheels 152 thereon may slide vertically up and down in the slot 164.

The axle 160 and wheels 152 are biased downwardly to the bottom of the slot by a biasing mechanism. In the illustrated embodiment, the biasing mechanism configured to bias the axle includes a spring bias. Referring to the cross-sectional FIG. 11, a biasing spring 170 is captured between an upper stop element 172 and a piston 174 that captures and holds the axle 160. The piston 174 and axle 160 are free to move vertically up and down in the vertical members 14 under the bias of the spring 170. The spring 170 and the position of the stop element 172 are configured, under the normal weight of the frame 12, to drive the axle and wheels to the low end of the slot. In that way, as illustrated in FIGS. 9 and 10, the wheels are driven to at least partially extend below the bottom end 15 of the vertical members 14. In that way the ends of the vertical members are above the bottom of the wheels and above a ground surface contacting the wheels. Thus, the frame is suspended on the wheels and is free to roll as a user walks or moves in the frame 12.

Should a user stumble, fall or otherwise put a significant amount of weight on the frame, the weight will drive the frame and the vertical members 14 downwardly against the bias of the springs. As shown in FIG. 11, the bottoms 15 of the vertical members 14 will contact the ground and prevent the wheels 152 from easily rotating further. In that way, the frame is effectively braked by the weight of the user. It then provides a four corner and stationary support for the frame to support the weight of the user and prevent a fall or other injury. In accordance with one feature of the invention, a rubber or plastic cap 17 might be used at the end of the vertical members to provide friction with a ground surface and further prevent rolling and movement of the frame once the weight-activated breaking system has been implemented. Once the user stands up again, or otherwise recovers from a stumble or fall, and the weight is removed from the frame 12, the springs 170 acts to bias the wheels 152 back toward the ground and back past the ends 15 of the vertical members 14 so that the frame may freely roll again.

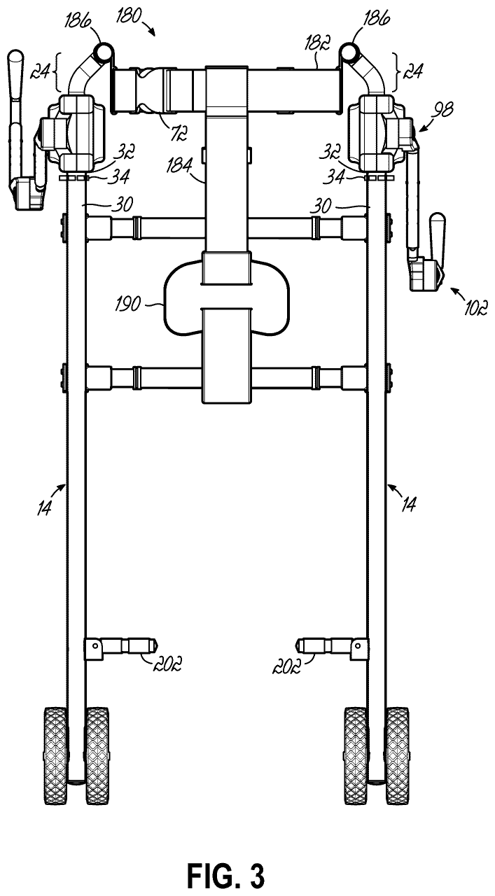

To further support a user and prevent a fall or to give a user a place to sit and rest in a rehabilitation process, the apparatus 10 incorporates a harness and seating assembly that the user can interface with. Specifically, referring to FIGS. 1 and 4 and other Figures, the apparatus 10 includes a harness 180 that a user can step into for support in the use of the apparatus. Referring to FIG. 3, the harness includes a torso or waist belt section 182 and a groin section 184. When a user is in the frame, as shown in FIG. 4, the torso section 182 wraps around the torso and the groin section 184 passes under the user and between the legs. Together, the sections 182, 184 of the harness 180 support the user in a stumble, fall or resting position. The harness is coupled with the frame 12 for support. Specifically, one or more loops 70, such as fabric loops, attach around the horizontal support members 20 to support the harness 180 from the sides of the frame 12. The loops 70 couple to the torso section 182 at various points on the side of the torso section for anchoring. Ends 66 or the torso section 182 and a front end of the groin section 184 are configured to snap into an appropriate harness buckle 64 similar to a vehicle seat belt engagement. The configuration of the ends 66 and buckle 64 can take a number of configurations wherein the ends click into the buckle and can be quickly released, such as with the push or a button or other actuator, as would be understood by a person of ordinary skill in the art. Each of the torso section 182 and groin section 184 are in the form of belts that might also have one or more buckle structures or other structures that allow a user to lengthen or shorten the sections 182, 184 as desired for a better fit. The end of the groin section 184, opposite the buckle 64, is coupled with the torso section. In one embodiment, the end of the groin section 184 includes a loop segment 67 that wraps around or otherwise engages the torso section for anchoring purposes. In that way, when a user falls or sits, the groin section captures the user and supports them from below and around the torso. In that way, both of the torso and groin section and the user are suspended from the frame, preventing a fall or other injury. As may be appreciated, other ways of attaching the harness 180 to the frame may be used. For example additional anchor points may be used that coupled the torso section or groin section with the frame 12.

For ease of entry when a user steps into the frame 12, generally from behind, the torso section might include another buckle 72 as shown in FIGS. 3 and 4 that can be undone so that a user may step into the torso section and then be secured. That will allow entry from behind the frame to allow a user to walk into the frame and attach the harness. The groin section 184 can then be brought up between the legs of a user and the end snapped into the buckle 64 to further secure the user with the harness and frame. So the user has the ability to walk into the frame, from the open rear side, and be secured. As noted, handles 200 might be gripped by a caregiver to initially or otherwise assist a user in walking and using the apparatus.

If a person desires to sit and rest while using apparatus 10, the apparatus of the invention provides a comfortable resting arrangement. To that end, a seat 190 may be supported on the groin section 184. The seat may be coupled on a sleeve 192 that is slidably coupled to the groin section to slide up and down on the groin section 184 for proper positioning and use. Referring to FIG. 1, the seat 190 might be moved up the groin section 184 to be out of the way of a walking user. Then, if the user desires to stop walking and have a break or a rest, they can slide the seat 190 down to a seat position below the bottom or buttocks of a user so the user can sit on the seat. The sleeve 192 is configured for a friction fit to be slid up and out of the way or down into the sitting position as desired. The seat 190 may be made of a suitable foam material or other material for comfort. The apparatus also includes foot pegs 202 that are secured in the front of the frame of the apparatus, as shown in FIG. 1. A sitting or otherwise resting user, who is supported by the harness, may place their feet on the foot pegs 202 for further comfort. The foot pegs are configured and operable to pivot on a hinge axis so they can be pivoted up against the vertical members 14 in the front of the frame 12. In that way, when a user is standing and walking as shown in FIG. 4, the footpegs will not interfere with the walking process or hit the users legs. FIG. 2 shows the foot pegs in the folded

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants'general inventive concept.

What is claimed is:

1. An apparatus for walking safety comprising:
a frame, the frame including four vertical members defining corners of the frame and a front, a rear and opposing sides;
each of the vertical members being adjustable in length to adjust a height of the frame;
at least one side beam coupled with vertical members on opposing sides of the frame;
at least one front horizontal member coupled between vertical members on the front of the frame, the at least one front horizontal member adjustable in length for adjusting the width of the frame;
horizontal support members coupled with vertical members on opposing sides of the frame, the horizontal support members coupled proximate to top ends of respective vertical members;
an arm structure coupled to the frame on either side of the frame;
a harness coupled to the frame for supporting a user of the apparatus.

2. The apparatus of claim 1 wherein at least one of the vertical members includes an outer tube and an inner tube that telescopes vertically in the outer tube for adjusting the length of the vertical member.

3. The apparatus of claim 2 wherein at least one of the vertical members includes a clamping mechanism to clamp the outer tube around the inner tube to fix the length of the vertical member.

4. The apparatus of claim 1 wherein the at least one front horizontal member coupled between vertical members includes a large diameter section and at least one smaller diameter section that telescopes in the larger diameter section to vary the length of the front horizontal member.

5. The apparatus of claim 4 wherein the sections of the front horizontal member are threaded and rotate relative to each other to telescope and vary the length of the front horizontal member.

6. The apparatus of claim 1 wherein the arm structure includes a plurality of arm sections and a plurality of elbow structures coupled with arm sections for allowing adjustment of the position of the arm structures with respect to the frame.

7. The apparatus of claim 1 wherein the arm structure includes a plurality of arm sections includes telescoping elements that can telescope with respect to each other to provide a length adjustability to the arm section.

8. The apparatus of claim 1 further comprising at least one wheel at the bottom end of each vertical member and an axle, a slot formed in the vertical member and the at least one wheel and axle sliding vertically in the slot, a biasing mechanism configured to bias the axle downwardly in the slot.

9. The apparatus of claim 8 wherein the vertical member has a bottom end, the at least one wheel extending below the bottom end when the axle is biased downwardly in the slot.

10. The apparatus of claim 1, the harness including a torso section and a groin section extending down from the torso section, a seat slidably coupled with the groin section.
